(19) United States
(12) Patent Application Publication
(10) Pub. No.: US 2024/0104465 A1
(43) Pub. Date: Mar. 28, 2024

(54) SYSTEMS AND METHODS TO MANAGE CONTRIBUTIONS AND COMPLIANCE IN A DECENTRALIZED USER ENVIRONMENT

(71) Applicant: Kronosapiens Labs, LLC, Santa Monica, CA (US)

(72) Inventors: Daniel Ben Kronovet, Santa Monica, CA (US); Seth Frey, Davis, CA (US); Joseph Alexander DeSimone, New York, NY (US)

(21) Appl. No.: 18/476,156

(22) Filed: Sep. 27, 2023

Related U.S. Application Data
(60) Provisional application No. 63/410,365, filed on Sep. 27, 2022.

(51) Int. Cl. G06Q 10/0631; G06Q 10/0639

(52) U.S. Cl. CPC G06Q 10/06316; G06Q 10/0639

(57) ABSTRACT

Systems and methods to manage prioritization and completion of chores within a contribution management environment and to manage values associated with user activity within a compliance environment are disclosed. Exemplary implementations may: manage environment information defining a contribution management environment; manage compliance environment information defining a compliance environment; determine a chore value of a chore based on, at least, a priority of the chore relative to other chores; receive completion requests indicating requests to update the contribution management environment to reflect completion of the chore by a user; update the contribution management environment responsive to receipt of sufficient approval of the completion request; periodically update the compliance environment to reflect satisfactory compliance of users; receive challenge requests indicating a request to update the compliance environment to reflect decreased compliance of a user; and update the compliance environment responsive to receipt of sufficient approval of the challenge request.

### FIELD OF THE DISCLOSURE

The present disclosure relates to systems and methods to manage the prioritization and completion of chores and to manage values associated with user activity.

### BACKGROUND

Cooperation environments for managing assignments and completion of chores are known. Cooperation environments for tracking compliance of users are known. Presenting such information in user interfaces is known.

### CROSS-REFERENCE TO RELATED APPLICATION

This application claims the benefit of U.S. Provisional Patent Application No. 63/410,365, filed Sep. 27, 2022, which is incorporated by reference herein in its entirety.

### SUMMARY

By virtue of the systems and methods described herein, the process of managing conduct or compliance of users and completion of chores within a cooperation environment may be improved. For example, a cooperation environment may include members of a shared living space, an office environment, an online community, and/or other types of environments. A cooperation environment may include a contribution environment and a compliance environment. Such environments may function together to improve the functioning of the cooperation environment. Automating prioritization of chores within a cooperation environment may provide more accurate and efficient prioritization. For example, complex schemes useful for efficient prioritization of chores may be calculated more accurately and efficiently when completed automatically. In some cases, manual updating of chore priorities may result in individual bias and/or inefficiencies. For example, bias may be characterized by self-serving and/or exploitative decisions being made. For example, in an environment using manual prioritization schemes for chores, calculating prioritization of the chores may become a chore itself, discouraging participation in the cooperation environment.

Additionally, automatically managing conduct of the users may add an abstraction to determination of compliance of the users within the cooperation environment. Such an abstraction may minimize risk of bias and increase efficiency in improving the conduct within the cooperation environment, as compared to manual and/or in-person methods, or methods requiring privileged administrator review. For example, manual systems for managing conduct of users may introduce inefficiencies through the necessitation of in-person meetings, or reliance on potentially biased or incompetent administrators. By virtue of the systems and methods described herein, such inefficiencies are mitigated.

One or more aspects of the present disclosure may relate to automatically managing prioritization of chores to be completed by users and values associated with the users. Automatically managing prioritization of chores to be completed by users may include a system configured to automatically manage prioritization of chores within a contribution management environment. The system may include non-transitory electronic storage media. The non-transitory electronic storage media may be configured to store environment information defining a contribution management environment. The contribution management environment may manage chores to be completed by users of the contribution management environment.

In some implementations, the environment information may include chore information for the chores managed by the contribution management environment, user information for the users of the contribution management environment, and/or other information. The chore information for individual ones of the chores may include a chore identifier, a description of the chore, a baseline chore value, a last performance timing, a chore valuing function, and/or other information. By way of non-limiting example, the chores may include a first chore. By way of non-limiting example, the environment information may include first chore information for a first chore. The first chore information may include a first chore identifier of the first chore, a first baseline chore value for the first chore, a last performance timing of the first chore, a first chore valuing function of the first chore, and/or other information.

In some implementations, the user information for individual ones of the users may include a user identifier, a contribution balance, and/or other information. In some implementations, the individual contribution balances associated with the individual ones of the users may characterize a current chore value of chores completed by the individual ones of the users. By way of non-limiting example, the users may include a first user. By way of non-limiting example, the user information may include first user information for the first user. The first user information may include a first user identifier of the first user, a first contribution balance associated with the first user, and/or other information.

The system may include one or more hardware processors configured by machine-readable instructions. The processor(s) may be configured to determine current chore values of the chores. In some implementations, the current chore values may be determined based on the chore valuing functions, the last performance timings of the chores, chore priority values, and/or other information. By way of non-limiting example, a first current chore value for the first chore may be determined based on the first chore valuing function, the last performance timing of the first chore, the chore priority values, and/or other information. The processor(s) may be configured to effectuate presentation of the current chore values to the users via individual client computing platforms associated with individual ones of the users. By way of non-limiting example, presentation of the current chore values including the first current chore value to the first user via a first client computing platform associated with the first user may be effectuated.

The processor(s) may be configured to receive a completion request from the first client computing platform. The completion request may indicate a request to update the contribution management environment such that completion of the first chore by the first user is reflected. By way of non-limiting example, the completion request may include information identifying the first user, information identifying the first chore, and/or other information. The processor(s) may be configured to transmit an indication of the completion request responsive to receipt of the completion request. By way of non-limiting example, the indication may be transmitted to the individual client computing platforms. By way of non-limiting example, the indication may identify the first user, the first chore, the first current chore value, and/or other information. In some implementations, the indication may enable one or more other users to approve the completion request via one or more client computing platforms associated with the one or more other users.

The processor(s) may be configured to receive approval of the completion request from one or more other users via the one or more client computing platforms. The processor(s) may be configured to determine whether the approval received is sufficient to update the contribution management environment. The processor(s) may be configured to update the contribution management environment. In some implementations, updating the contribution management environment may include updating the first contribution balance associated with the first user. By way of non-limiting example, the first contribution balance may reflect the first chore value responsive to being updated. In some implementations, updating the contribution management environment may include updating the first current chore value of the first chore.

One aspect of the present disclosure relates to a system configured to automatically manage values associated with user activity within a compliance environment. The system may include non-transitory electronic storage media. The non-transitory electronic storage media may be configured to store compliance environment information defining a compliance environment. The compliance environment information may include compliance information associated with individual ones of the users, an amount of time, a last automatic update timing, an automatic update amount, and/or other information. The compliance information for individual ones of the users may include a user identifier associated with an individual user, a current compliance supply associated with the individual user, and/or other information. By way of non-limiting example, first compliance information for a first user may include a first user identifier, a first current compliance supply, and/or other information. In some implementations, current compliance supplies may characterize levels of compliance of individual users at a particular point in time. In some implementations, the amount of time may denote an amount of time between automatic increases in current compliance supplies of the users. In some implementations, the compliance environment may automatically manage compliance supplies of users of the compliance environment.

The system may include one or more hardware processors configured by machine-readable instructions. The processor(s) may be configured to determine passage of the amount of time since the last compliance supply update timing. The processor(s) may be configured to update the current compliance supplies. In some implementations, individual ones of the current compliance supplies may reflect an increase of the automatic update amount responsive to the determination of passage of the amount of time. The processor(s) may be configured to receive a challenge request from a first client computing platform associated with the first user. The challenge request may indicate a request to update the compliance environment such that a second compliance supply associated with a second user is lowered by a first amount. The challenge request may include information identifying the second user, information identifying the first amount, and/or other information.

The processor(s) may be configured to determine an approval minimum indicating a minimum number of users required to approve the challenge request. In some implementations, the approval minimum may be determined based on the second compliance supply. The processor(s) may be configured to transmit an indication of the challenge request to one or more client computing platforms. The indication may identify the first user, the second user, the first amount, the approval minimum, and/or other information. In some implementations, the indication of the challenge request may enable one or more users to approve the challenge request via the one or more client computing platforms. The processor(s) may be configured to receive approval of the challenge request from one or more client computing platforms associated with one or more users. The processor(s) may be configured to determine approval of the challenge request has been received from a number of users greater than or equal to the approval minimum.

The processor(s) may be configured to update the compliance environment such that the second compliance supply is lowered by the first amount. In some implementations, the compliance environment may be updated responsive to the determination. The processor(s) may be configured to transmit an indication of the decrease to the second compliance supply to one or more client computing platforms.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to automatically manage prioritization and completion of chores within a contribution management environment.

FIG. 2 illustrates a system configured to automatically manage values associated with user activity within a compliance environment.

FIG. 3 illustrates a method of automatically managing prioritization and completion of chores within a contribution management environment.

FIG. 4 illustrates a method of automatically managing values associated with user activity within a compliance environment.

FIG. 5 illustrates an exemplary user interface for transmitting a challenge request from a client computing platform.

FIG. 6 illustrates an exemplary user interface for submitting a completion request.

FIG. 7 illustrates an exemplary user interface for submitting a completion request.

FIG. 8 illustrates an exemplary user interface depicting indications of activity within a contribution management environment.

FIG. 9 illustrates an exemplary user interface for submitting a priority increase request.

### DETAILED DESCRIPTION

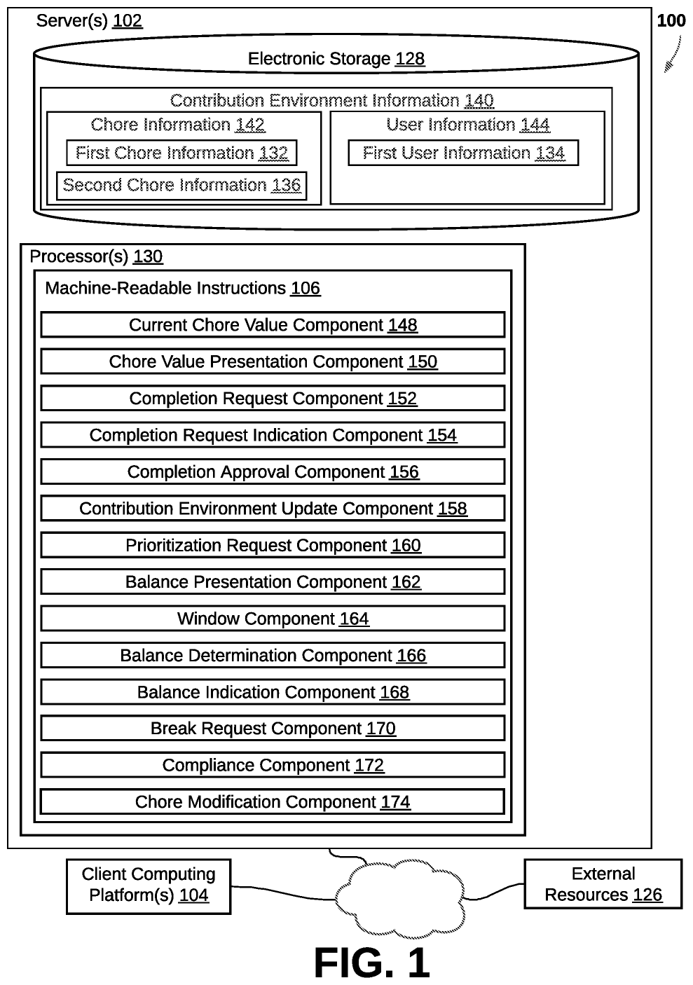

FIG. 1 illustrates a system 100 configured to automatically manage prioritization and completion of chores within a contribution management environment, in accordance with one or more implementations. In some implementations, the contribution management environment may manage chores to be completed by users of the contribution management environment. As used herein, the term “chore” may refer to a repeating task. In some implementations, system 100 may include one or more servers 102, one or more client computing platforms 104, external resources 126, electronic storage 128, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Electronic storage 128 may include non-transitory electronic storage media. Electronic storage 128 may be configured to store contribution environment information 140 defining the contribution management environment. In some implementations, contribution environment information 140 may include a window duration, chore information 142 for the chores managed by the contribution management environment, user information 144 for the users of the contribution management environment, and/or other information. In some implementations, the window duration may indicate a duration of a window of time for tracking participation of users with the contribution management environment. In some implementations, the window of time may be recurring, current, periodic, and/or at another frequency. Chore information 142 for individual ones of the chores may include a chore identifier, a baseline chore value, a last performance timing, a chore valuing function, a priority value, a description of the chore, and/or other information.

In some implementations, contribution environment information 140 may include chore information 142 for pre-defined chores. By way of non-limiting example, chore information 142 for individual ones of the pre-defined chores may include a chore identifier, a baseline chore value, a last performance timing, a chore valuing function, a priority value, a description of the chore, and/or other information. By way of non-limiting example, a pre-defined chore may be a chore that has been defined by one or more users of the contribution management environment. In some implementations, chore information 140 may include chore information 142 for chores that have not yet been defined within the contribution management environment. By way of non-limiting example, chore information 142 for individual ones of the chores that have not yet been defined within the contribution management environment may include one or more of a chore identifier, a description of the chore, and/or other information. For example, a chore that has not yet been defined may not be associated with a baseline chore value, a chore valuing function, a priority value, a current chore value, and/or other information associated with a chore value of the chore.

In some implementations, a chore value may be an amount to be awarded to an individual user upon completion of an individual chore by the individual user. In some implementations, a baseline chore value may indicate an initial chore value of a chore at initiation of the contribution management environment, upon completion of the chore, and/or at other times. In some implementations, a baseline chore value may be equivalent to a value of zero, one, two, and/or any other number. As used herein, the term “last performance timing” may refer to information that directly indicates a moment or point in time at which the chore was last performed, and/or information from which a moment or point in time at which the chore was last performed may be determined, inferred, calculated, or otherwise obtained.

As used herein, the term “chore valuing function” may refer to a function characterizing individual chore values of individual chores as a function of amounts of time passed since completion of the individual tasks and/or since initiation of the contribution management environment. In some implementations, an individual chore valuing function may be linear, non-linear, exponential, piecewise, logarithmic, and/or another type of function. In some implementations, an individual chore valuing function of a chore may be based on the baseline chore value of the chore and the priority value of the chore. By way of non-limiting example, the individual chore valuing function maybe a linear function. For example, an individual priority value of a chore may characterize priority of the chore within the contribution management environment. In some implementations, the individual priority value of the chore may be determined based on individual priority values of other chores managed by the contribution management environment. By way of non-limiting example, priority values of the chores managed by the contribution management environment sum to a constant value at one or more given times. By way of non-limiting example, an individual priority value of a chore may directly and/or indirectly characterize growth over time of a chore value of the chore. As such, growth over time of a chore value of the chore may reflect the individual priority value of the chore. By way of non-limiting example, growth over time of a chore value of a chore may be the same as and/or determined based on a priority value of the chore. In some implementations, an update to growth over time of a chore value of the chore may update the individual priority value.

By way of non-limiting example, the chores may include a first chore, a second chore and/or other chores. By way of non-limiting example, contribution environment information 140 may include first chore information 132 for the first chore. First chore information 132 may include a first chore identifier of the first chore, a first baseline chore value of the first chore, a last performance timing of the first chore, a first chore valuing function of the first chore, a first priority value, and/or other information. By way of non-limiting example, contribution environment information 140 may include second chore information 136 for the second chore. Second chore information 136 may include a second chore identifier of the second chore, a second baseline chore value of the second chore, a last performance timing of the second chore, a second chore valuing function of the first chore, a second priority value, and/or other information. In some implementations, a window duration included in contribution environment information 140 may denote a length of time of windows for tracking contribution balances of the users.

In some implementations, user information 144 for individual ones of the users may include a user identifier, a contribution balance, a contribution balance requirement, and/or other information. For example, an individual contribution balance may reflect a magnitude of contribution to the contribution management environment by an individual user. For example, contribution to the contribution management environment may include completion of a chore managed by contribution management environment by a user. In some implementations, an individual contribution balance may reflect chore values of chores completed by an individual user during a sliding window of time or during a current window of time. An individual contribution balance requirement may denote minimum contribution balances to be associated with individual ones of the users at the conclusion of a particular window of time. As such, an individual contribution balance requirement may indicate a minimum magnitude of contribution to the contribution management environment by a user during a particular window of time.

By way of non-limiting example, the users may include a first user and/or other users. By way of non-limiting example, the user information may include first user information 134 for the first user. First user information 134 may include a first user identifier of the first user, a first contribution balance associated with the first user, a first contribution balance requirement, and/or other information. The first contribution balance requirement may denote a minimum contribution balance to be associated with the first user at the conclusion of a particular window of time.

Server(s) 102 may be configured by machine-readable instructions 106. Machine-readable instructions 106 may include one or more instruction components. The instruction components may include computer program components. The instruction components may include one or more of a current chore value component 148, a chore value presentation component 150, a completion request component 152, a completion request indication component 154, a completion approval component 156, a contribution environment update component 158, a prioritization request component 160, a balance presentation component 162, a window component 164, a balance determination component 166, a balance indication component 168, a break request component 170, a compliance component 172, a chore modification component 174, and/or other instruction components.

Current chore value component 148 may be configured to determine current chore values of the chores based on one or more of the chore valuing functions included in chore information 142, the last performance timings included in chore information 142, and/or other information. By way of non-limiting example, a first current chore value for the first chore may be determined based on one or more of the first chore valuing function, the first baseline chore value, the first priority value, and the last performance timing of the first chore, and/or other information. By way of non-limiting example, the first current chore value may be determined by evaluating the first chore valuing function based on the first baseline chore value and the first priority value.

In some implementations, the current chore value may have been determined instantaneously and/or near instantaneously. In some implementations, current chore value component 148 may be configured to determine the current chore values in a recurrent manner, periodically, at least once, and/or with other frequencies. In some implementations, individual chore valuing functions may limit growth of a current chore value beyond a particular threshold.

Chore value presentation component 150 may be configured to effectuate presentation of the current chore values to the users via individual ones of client computing platform(s) 104. In some implementations, the presentation may be visible by one or more users via one or more user interfaces on one or more client computing platforms 104. By way of non-limiting example, chore value presentation component 150 may be configured to effectuate presentation of the first current chore value to the first user via a first client computing platform associated with the first user. The first client computing platform may be an individual one of one or more client computing platforms 104. In some implementations, the presentation of the first current chore value may be visible to the first user via a first user interface on the first client computing platform. In some implementations, chore value presentation component 150 may be configured to effectuate presentation of the current chore values responsive to the contribution management environment being updated. In some implementations, chore value presentation component 150 may be configured to effectuate presentation of the current chore values responsive to one or more current chore values being updated.

Balance presentation component 162 may be configured to effectuate presentation of the contribution balances to the users via one or more client computing platforms 104. In some implementations, balance presentation component 162 may be configured to effectuate presentation of the contribution balances responsive to the contribution management environment being updated. In some implementations, balance presentation component 162 may be configured to effectuate presentation of the contribution balances responsive to one or more contribution balances being updated.

Completion request component 152 may be configured to receive completion requests from one or more client computing platforms 104 associated with one or more users. In some implementations, a completion request may be received responsive to an individual user entering and/or selecting the completion request via one or more client computing platforms 104. In some implementations, a completion request may indicate a request to update the contribution management environment such that reflection of completion of an individual chore by one or more users. In some implementations, a completion request may identify one or more of a chore claimed to be completed, one or more users claimed to have completed the chore, a point in time of the claimed completion of the chore, and/or other information.

By way of non-limiting example, a first completion request may be received from the first client computing platform. The first completion request may indicate a first request to update the contribution management environment. By way of non-limiting example, the first completion request may indicate a request to update the contribution management environment such that completion of the first chore by one or more users is reflected. For example, the first completion request may identify one or more of the first chore, the first user, a first point in time, and/or other information. The first point in time may refer to information that directly indicates a claimed point in time at which the chore was last completed by the first user. By way of non-limiting example, the one or more users may include the first user. As such, the first completion request may indicate a request to update the contribution management environment such that completion of the first chore by the first user is reflected. In some implementations, the first completion request may include information identifying the first user, information identifying the first chore, and/or other information.

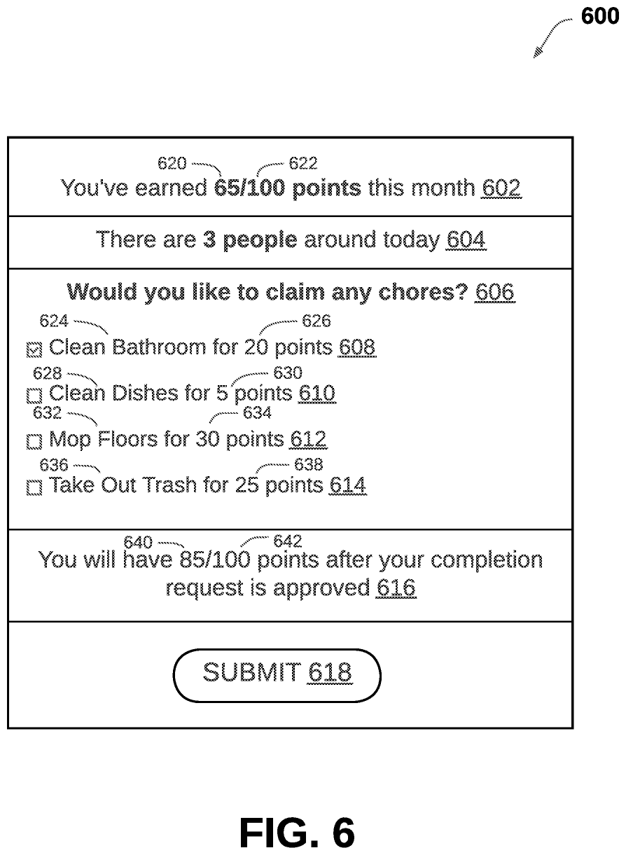

FIG. 6 illustrates an exemplary user interface 600 for submitting a completion request. By way of non-limiting example, user interface 600 may be presented to a user. By way of non-limiting example, user interface 600 may include current contribution balance information 602, a number of users 604, a completion request field 606, expected contribution balance information 616, and a submission button 618. Current contribution balance information 602 may include a current contribution balance 620 of the user and a contribution balance requirement 622 for the user. Number of users 604 may indicate a number of users active within a contribution management environment on a particular day. By way of non-limiting example, a number of users taking a break on the particular day may not be included in number of users 604. Expected contribution balance information 616 may include an expected contribution balance 640 and a contribution balance requirement 642. By way of non-limiting example, contribution balance 640 may indicate an expected contribution balance of the user upon approval of a chore completion request indicating chore 608.

Completion request field 606 may include a chore 608, a chore 610, a chore 612, and a chore 614. Completion request field 606 may enable the user to select one or more of chore 608, chore 610, chore 612, and/or chore 614. One or more completion requests may be submitted for individual ones of the selected chores. Chore 608 may include a chore identifier 624 and a current chore value 626. Chore 610 may include a chore identifier 628 and a current chore value 630. Chore 612 may include a chore identifier 632 and a current chore value 634. Chore 614 may include a chore identifier 636 and a current chore value 638. In some implementations, selection of individual ones of chore 608, chore 610, chore 612, and chore 614 may update expected contribution balance 616 to reflect completion of the individual ones. For example, selection of chore 608 may update expected contribution balance 616 to reflect chore value 626. Selection of submission button 618 may effectuate transmission of a completion request indicating chore 608.

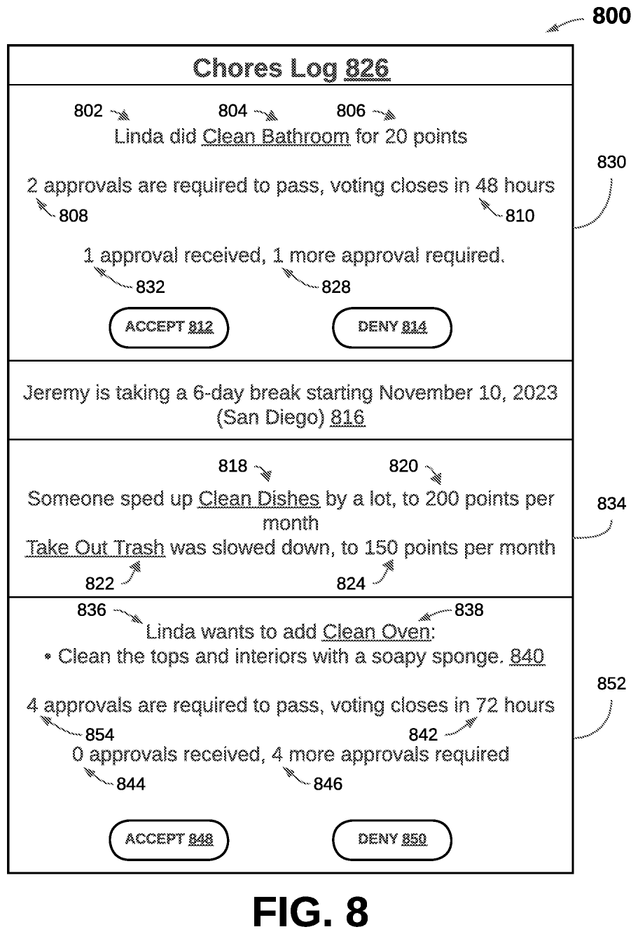

FIG. 8 illustrates an exemplary user interface 800 depicting indications of activity within a contribution management environment. By way of non-limiting example, user interface 800 may depict a chore log 826 of activity. User interface 800 may include an completion request indication 830. Completion request indication 830 may be an indication of a completion request indicating chore 608 depicted in FIG. 6. Completion request indication 830 may include a user identifier 802, a chore identifier 804, and a current chore value 806. By way of non-limiting example, user identifier 802 may identify a user associated with a client computing platform from which the completion request was received. By way of non-limiting example, chore identifier 804 may be an identifier of chore 608. Current chore value 806 may be the current chore value at a time of receipt of the completion request. Completion request indication 830 may include a minimum number of users 808 required for approval of the completion request, a deadline 810 for approval of the completion request, a current number of approvals 832, and a remaining number of approvals 828. Completion request indication 830 may include an accept button 812 configured to receive user approval of the completion request. Completion request indication 830 may include a deny button 814 configured to receive user denial of the completion request.

Referring back to FIG. 1, completion request indication component 154 may be configured to transmit indications of completion requests responsive to receipt of the completion requests. In some implementations, the indications may be transmitted to one or more client computing platforms 104. In some implementations, individual indications of completion requests may present some or all of the information identified by the completion requests. For example, the information identified by the completion requests may include one or more of a chore, one or more users, a time, and/or other information. By way of non-limiting example, completion request indication component 154 may be configured to transmit a first indication of the first completion request. By way of non-limiting example, the first indication may identify one or more of the first user, the first chore, the first current chore value, and/or other information. In some implementations, an individual indication may enable one or more other users to approve the completion request via one or more client computing platforms 104 associated with the one or more other users. By way of non-limiting example, a second user may approve the first completion request via a second client computing platform associated with the second user. An approval of the completion request by the second user may indicate the second user approving that one or more users completed the first chore.

Completion approval component 156 may be configured to receive approval of completion requests from one or more other users. In some implementations, approval may be received from one or more client computing platforms 104 associated with one or more users. For example, individual users may enter and/or select approval of individual completion approval requests via one or more client computing platforms 104. By way of non-limiting example, a first set of one or more approvals of the first completion request may be received from one or more users via one or more client computing platforms 104.

Completion approval component 156 may be configured to determine whether or not received approval of a completion request is sufficient to update the contribution management environment. In some implementations, determining the approval received is sufficient may include determining a number of users from which approval of the completion request has been received. In some implementations, determining the approval received is sufficient may include determining the number of users is greater than or equal to a minimum number of users. In some implementations, the minimum number of users may be a number of users required for approval of the completion request. In some implementations, the minimum number of users may be a preset amount, an amount entered and/or selected by a user, an amount automatically determined based on a contribution balance of a user, and/or determined in another way.

In some implementations, the minimum number of users may be the same for some or all of the users and/or determined uniquely for individual users. In some implementations, approval of a completion request from a user may not be included in the number of users by virtue of the completion request being from the user. In some implementations, a user may be considered to have approved the completion request by virtue of selecting and/or entering the completion request. By way of non-limiting example, completion approval component 156 may be configured to determine if approval of the first completion request is sufficient to update the contribution management environment.

Contribution environment update component 158 may be configured to update the contribution management environment. In some implementations, the contribution management environment may be updated such that completion of individual chores by one or more users is reflected. In some implementations, the contribution management environment may be updated responsive to receiving sufficient approval of a completion request (e.g., as determined by completion approval component 156). In some implementations, updating the contribution management environment may include updating one or more contribution balances associated with one or more users identified by the completion request. Responsive to the update, the one or more contribution balances may reflect a chore value of a chore identified by the completion request. By way of non-limiting example, the chore value may have been a current chore value of the chore at a particular point in time of completion of the chore as may be identified in the completion request, of reservation of the chore, of receipt of the completion request, and/or another time.

In some implementations, a particular point in time of reservation of a chore may indicate a point in time of an individual user claiming the chore for completion. For example, such a reservation may be received from one or more client computing platforms 104. By way of non-limiting example, upon receipt of the reservation, the growth over time of a chore value associated with the chore may be stopped and/or slowed. The growth over time may be stopped and/or slowed until a point in time of receipt of a completion request indicating the individual user and the chore, until update to the contribution management environment responsive to the completion request, and/or until another time.

By way of non-limiting example, the contribution management environment may be updated such that completion of the first chore the one or more users identified by the first completion request is reflected. For example, completion of the first chore by at least the first user may be reflected. The one or more users may be associated with one or more contribution balances. By way of non-limiting example, the one or more contribution balances may be updated such that the one or more contribution balances reflect the first current chore value. In some implementations, the one or more contribution balances reflecting the first current chore value may include adding the first current chore value to the one or more contribution balances. For example, the first current chore value may be distributed evenly or unevenly among the one or more contribution balances. For example, the entirety of the first current chore value may be added to and/or otherwise reflected by individual ones of the one or more contribution balances. Other methods may be used such that the first chore value is reflected by the one or more contribution balances responsive to being updated. By way of non-limiting example, the first contribution balance may reflect the entirety of and/or a portion of the first current chore value responsive to being updated.

By way of non-limiting example, updating the contribution management environment may include updating the first current chore value of the first chore. By way of non-limiting example, the first current chore value may be set to zero, the first baseline chore value, and/or another value responsive to being updated. For example, the first current chore value being zero may characterize the completion of the first chore having no value at a particular time. By way of non-limiting example, the first current chore value being zero may characterize completion of the first chore has been claimed by one or more users very recently. For example, updating the contribution management environment may include updating the last performance timing of the first chore. In some implementations, the last performance timing of the first chore may be updated to indicate a point in time of receipt of the first completion request, the first point in time, and/or another point in time.

Priority request component 160 may be configured to receive a priority change request from one or more client computing platforms 104. The priority change request may include a priority increase request, a priority decrease request, a priority lock request, and/or another type of request. In some implementations, the priority change request may indicate a request to change priority value of a chore managed by the contribution management environment. In some implementations, the priority change request may include a chore identifier of the chore, one or more chore identifiers of one or more other chores, and/or other information.

By way of non-limiting example, the priority change request may include the first chore identifier and one or more chore identifiers of one or more other chores. By way of non-limiting example, the one or more other chores may include the second chore. In some implementations, a priority increase request may indicate a request to prioritize the chore relative to the one or more other chores. By way of non-limiting example, a first priority change request may include a priority increase request indicating a request to increase priority of and/or prioritize the first chore relative to one or more other chores. In some implementations, increasing priority of the first chore may result in the first priority value being increased. In some implementations, a priority decrease request may indicate a request to decrease priority of the chore relative to the one or more other chores. By way of non-limiting example, a second priority change request may include a priority decrease request indicating a request to decrease the priority of the first chore relative to one or more other chores.

In some implementations, decreasing priority of the first chore may result in the first priority value being decreased. In some implementations, a magnitude of change to a priority of a chore identified by a priority change request may be determined based on a number of other chores identified by the priority change request. For example, a priority change request may identify a particular chore. For example, the priority change request identifying a higher number of other chores may have a higher magnitude of effect on priority of the particular chore than the priority change request identifying a lower number of other chores.

Contribution management environment update component 158 may be configured to update a current chore value of the chore, one or more current chore values of the one or more other chores, and/or other current chore values. In some implementations, updating a current chore value may include updating and/or changing individual ones of a subset of chore information 142. In some implementations, the subset may include one or more a baseline chore value, a chore valuing function, and/or other information included in chore information 142. In some implementations, updating and/or changing an individual chore valuing function of an individual chore may update and/or change the growth over time of the chore value of the individual chore. In some implementations, updating and/or changing growth over time of the chore value of the individual chore may update and/or change the individual chore valuing function. In some implementations, updating and/or changing the individual chore valuing function may including updating and/or changing a priority value of the individual chore.

By way of non-limiting example, contribution management environment update component 158 may be configured to update the second current chore value. Updating the second current chore value may include updating the baseline second chore value, the second chore valuing function, the second priority value, and/or another value associated with the second chore. By way of non-limiting example, the second current chore value may be updated such that the second current chore value is decreased and/or lowered responsive to receipt of the first priority change request. For example, decreasing the second current chore value may include decreasing and/or lowering the second baseline chore value, modifying the second chore valuing function, decreasing and/or lowering the second priority value, and/or modifying other information associated with the second chore. The second chore valuing function may be modified such that growth over time of the chore value of the second current is decreased and/or lowered. By way of non-limiting example, the second priority value may be decreased and/or lowered. Decreasing the second priority value may decrease growth over time of the second chore value.

By way of non-limiting example, the first current chore value may be updated. In some implementations, updating the first current chore value may include increasing the first baseline chore value, the first chore valuing function, the first priority value, and/or another value associated with the first chore. As such, the first current chore value and/or growth over time of the first chore value may be increased. Such increase may be reflective of the lowering of the baseline chore values and/or the lowering of the growth over time of the chore values of the one or more other chores. By way of non-limiting example, the first priority value may be increased. Such an increase may be reflective of the decrease to the second priority value.

By way of non-limiting example, the second current chore value may be increased responsive to receipt of the second priority change request. For example, increasing the second current chore value may include increasing the second baseline chore value, modifying the second chore valuing function, increasing the second priority value, and/or modifying other information associated with the second chore. Modifying the second chore valuing function may increase growth over time of the chore value of the second chore value. By way of non-limiting example, the second priority value may be increased. Increasing the second priority value may increase growth over time of the second chore value. By way of non-limiting example, the first current chore value may be updated. In some implementations, updating the first current chore value may include decreasing the first baseline chore value, the first chore valuing function, the first priority value, and/or another value associated with the first chore. As such, the first current chore value and/or growth over time of the first chore value may be decreased. Such a decrease may be reflective of the increase of the baseline chore values and/or the increase of the growth over time of the chore values of the one or more other chores. By way of non-limiting example, the first priority value may be decreased. Such a decrease may be reflective of the increase to the second priority value.

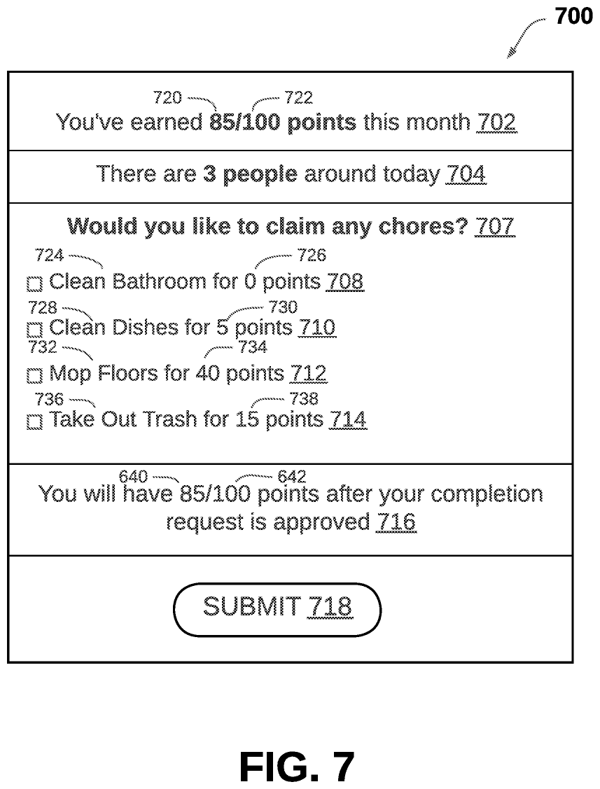

FIG. 7 illustrates an exemplary user interface 700 for submitting a completion request. By way of non-limiting example, user interface 700 may be the same as or similar to user interface 600 depicted in FIG. 6 responsive to being updated. User interface 700 may include current contribution balance information 702, a number of users 704, a completion request field 706, expected contribution balance information 716, and a submission button 718. Current contribution balance information 702 may include a current contribution balance 720 of the user and a contribution balance requirement 722 for the user. Expected contribution balance information 716 may include an expected contribution balance 740 and a contribution balance requirement 742. Completion request field 706 may include a chore 708, a chore 710, a chore 712, and a chore 714. Completion request field 706 may enable the user to select one or more of chore 708, chore 710, chore 712, and/or chore 714. One or more completion requests may be submitted for individual ones of the selected chores. Chore 708 may include a chore identifier 724 and a current chore value 726. By way of non-limiting example, current chore value 726 may reflect a current chore value of 0 points by virtue of a completion request indicating chore 708 being approved.

Chore 710 may include a chore identifier 728 and a current chore value 730. Chore 712 may include a chore identifier 732 and a current chore value 734. Chore 714 may include a chore identifier 736 and a current chore value 738. In some implementations, selection of individual ones of chore 708, chore 710, chore 712, and chore 714 may update expected contribution balance 716 to reflect completion of the individual ones. By way chore 712 and chore 714 may be the same as or similar to chore 612 and chore 614 depicted in FIG. 6. Current chore value 734 may reflect a higher prioritization of chore 712 than current chore value 634 (depicted in FIG. 6) responsive to a priority increase request. The priority increase request may indicate a request to increase a priority of chore 712 relative to a priority of chore 714. As such, current chore value 738 may reflect a lower prioritization of chore 714 than current chore value 638 (depicted in FIG. 6).

User interface 800, depicted in FIG. 8, may include a prioritization increase indication 834. By way of non-limiting example, increase indication 834 may include a chore identifier 818 of a first chore, a current chore value 820 of the first chore, a chore identifier 822 of a second chore, and a current chore value 824 of the second chore. By way of non-limiting example, the prioritization increase indication may be responsive to a prioritization increase request indicating the first chore and the second chore.

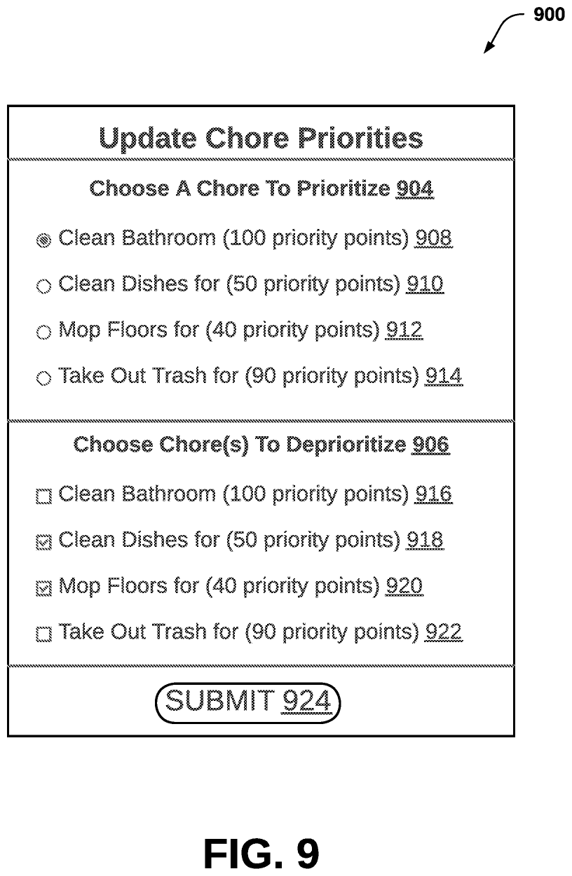

FIG. 9 depicts an exemplary user interface 900 for submitting a priority increase request. User interface 900 may include a chore selection field 904, a chore selection field 906, and a submission button 924. Chore selection field 904 may be configured to receive selection of a chore 908, a chore 910, a chore 912, or a chore 914. Selection of a chore via chore selection field 904 may indicate selection of a chore for which to request prioritization using a priority increase request. Chore selection field 906 may be configured to receive a selection of one or more of a chore 916, a chore 918, a chore 920, and/or a chore 922. Selection of one or more chores via chore selection field 906 may indicate selection of a chore for which to request remove priority using a priority increase request. Individual ones of chore 908, chore 910, chore 912, chore 914, chore 916, chore 918, chore 920, and chore 922 may include individual numbers of priority points. By way of non-limiting example, an individual number of priority points may indicate a priority value of an individual chore.

Referring back to FIG. 1, window component 164 may be configured to determine a window of time has concluded. By way of non-limiting example, window component 164 may be configured to determine a first window has concluded. In some implementations, determining a window of time has concluded may include determining an amount of time since the individual contribution balances associated with individual ones of the users have been reset. In some implementations, determining the window of time has concluded may include determining the amount of time is greater than or equal to the window duration included in contribution environment information 140. In some implementations, determining the window of time has concluded may initiate start of a new window of time. By way of non-limiting example, determining the first window has concluded may initiate start of a second window. The second window may have the same window duration as the first window or a different window duration.

Balance determination component 166 may be configured to determine one or more users do not satisfy the one or more contribution balance requirements. In some implementations the one or more users may be determined to not satisfy the one or more contribution balance requirements during a particular window. In some implementations, determining one or more users do not satisfy the one or more contribution balance requirements may include determining contribution balances of the one or more users do not satisfy the one or more contribution balance requirements of the one or more users. By way of non-limiting example, a user not satisfying an individual contribution balance requirement may indicate the user was not compliant within the contribution management environment during a particular window. In some implementations, balance determination component 166 may be configured to determine an individual contribution balance of an individual user does not satisfy the individual contribution balance requirement of the individual user.

By way of non-limiting example, determining the first contribution balance does not satisfy the first contribution balance requirement may include determining the individual contribution balance is less than, greater than and/or equal to the first contribution balance requirement. In some implementations, balance determination component 162 may be configured to determine the first contribution balance is less than the first contribution balance requirement. In some implementations, determining the first contribution balance is less than the first contribution balance requirement may be responsive to determining the first window has concluded. By way of non-limiting example, an individual user not satisfying an individual contribution balance requirement may indicate the individual user is not compliant with the contribution management environment.

Balance indication component 168 may be configured to transmit an indication that the one or more contribution balances do not satisfy the one or more contribution balance requirements. In some implementations, the indication may be transmitted to users via one or more client computing platforms 104. In some implementations, the indication may be transmitted to some users, all users, only user(s) not satisfying the contribution balance requirement, only user(s) satisfying the contribution balance requirement, and/or other sets of one or more users. In some implementations, the indication may identify the one or more users that do not satisfy the one or more contribution balance requirements, one or more users that do satisfy the contribution balance requirements, and/or other information. In some implementations, the indication may denote a window and/or period of time for which the one or more users do not satisfy the one or more contribution balance requirements.

Contribution environment update component 158 may be configured to reset the contribution balances of the users of the contribution management system. In some implementations, the contribution balances of the users may be reset responsive to determination of an individual window of time concluding. In some implementations, responsive to the reset, the contribution balances may reflect the users have not completed any chores during a new window of time. By way of non-limiting example, the contribution balances of the users may reflect the users have not completed any chores during the second window. By way of non-limiting example, responsive to the reset, the first contribution balance may be zero, a baseline value, a low value, a high value, and/or another value. In some implementations, a contribution balance greater than a contribution balance requirement may maintain a magnitude of value above the contribution balance requirement across a new window of time. For example, responsive to the reset, the first contribution balance may be equal to a difference between the first compliance and the first compliance requirement

Break request component 170 may be configured to receive individual break requests associated with individual users. In some implementations, the individual break requests may be received from one or more client computing platforms 104. By way of non-limiting example, break request component 170 may be configured to receive a first break request associated with the first user from the first client computing platform. In some implementations, the first break request may be associated with the first user by virtue of being received from the first client computing platform. In some implementations, a break request may indicate a user will be temporarily absent from the contribution management environment during one or more windows of time. By way of non-limiting example, a user being absent from the contribution management environment may include the user being unable to complete chores. By way of non-limiting example, a user may submit a break request due to having a planned trip, break, recovery period, an unplanned recovery period, and/or another reason. In some implementations, the break request may indicate a duration of, a time frame of, a reason for, an explanation of, and/or other information regarding absence of the first user from the contribution management environment. By way of non-limiting example, the first break request may indicate the first user will be absent for a first duration of time during an individual window.

Break request component 170 may be configured to determine individual break requests are valid. In some implementations, determining the validity of a break request may include determining whether the duration of absence is greater than or equal to a minimum break duration. In some implementations, determining the validity of the break request may include determining whether the duration of absence is less than or equal to a maximum break duration. In some implementations, determining a break request is valid may include determining a user associated with the break request is eligible to take a break and/or other determinations. By way of non-limiting example, break request 170 may be configured to determine the first break request is a valid break request. For example, determining the first break request is valid may include determining the first duration of time is greater than or equal to the minimum duration. For example, determining the first break request is valid may include determining the first duration of time is less than or equal to the maximum duration.

By way of non-limiting example, user interface 800 (depicted in FIG. 8) may include a break indication 816. By way of non-limiting example, break indication 816 may identify a user, a break duration, a start date of the break, and a reason for the break. By way of non-limiting example, break indication 816 may be presented responsive to receipt of a break request identifying the user, the break duration, the start date of the break, and/or the reason for the break.

Referring back to FIG. 1, contribution environment update component 158 may be configured to update contribution balance requirements associated with individual users. In some implementations, the contribution balance requirements for individual users may be updated responsive to determining break requests associated with the individual users are valid. In some implementations, the contribution balance requirements may be lowered by a value reflective of the duration of absence. As such, a user may be expected to complete a magnitude of chores during an individual window reflective of portion of the individual window for which the user is present in the contribution management environment. By way of non-limiting example, the first contribution balance requirement may be updated responsive to determining the first break request is a valid break request. For example, the first contribution balance requirement may be lowered to reflect the first duration of time.

Contribution environment update component 158 may be configured to update chore valuing functions of individual chores. In some implementations, the chore valuing functions of the individual chores may be updated responsive to determining break requests associated with the individual users are valid. For example, the chore valuing functions of the chores may be updated such that growth over time of chore values of the chores may be slowed during time frames of absence of individual users indicated by the break request. For example, the growth over time of an individual chore value at a particular time may be slowed by a magnitude reflective of a number of users absent from the contribution environment at the particular time.

Chore modification component 174 may be configured to receive chore modification requests from one or more client computing platforms 104 associated with one or more users. In some implementations, a chore modification request may be received responsive to an individual user entering and/or selecting the modification request via one or more client computing platforms 104. In some implementations, an indication of a chore modification request may be transmitted to one or more client computing platforms 104 responsive to receipt of the chore modification request. In some implementations, a chore modification request may include a chore addition request, a chore removal request, and/or a chore change request. In some implementations, a chore modification request may indicate a request to update the contribution management environment such that addition, removal, and/or change of one or more chores is reflected. In some implementations, an individual chore modification request may include a subset of the chore information for the one or more chores. By way of non-limiting example, an individual chore modification request may include one or more of a chore identifier of a chore, a description of the chore, a reasoning for the request, and/or other information.

By way of non-limiting example, a chore addition request may indicate a request to update the contribution management environment such that addition of a chore to be managed by the contribution management environment is reflected. For example, a chore addition request may include one or more of a chore identifier of a new chore, a description of the new chore, and/or other information. In some implementations, the new chore may be defined by virtue of the chore addition request including one or more of a chore identifier of the new chore, a description of the new chore, and/or other information associated with the new chore. By way of non-limiting example, a chore removal request may indicate a request to update the contribution management environment such that an individual chore is no longer to be managed by the contribution management environment. For example, a chore removal request may include a chore identifier and/or other information. By way of non-limiting example, a chore change request may indicate a request to update the contribution management environment such that chore information for a chore is changed and/or updated. For example, a chore change request may include a chore identifier and/or other information.

Chore modification component 174 may be configured to receive approval of chore modification requests from one or more client computing platforms 104. Chore modification component 174 may be configured to determine whether or not received approval of a chore modification request is sufficient to update the contribution management environment. In some implementations, determining whether the approval received is sufficient may include determining a number of users from which approval of the chore modification request has been received. In some implementations, determining the approval received is sufficient may include determining the number of users is greater than or equal to a minimum number of users. In some implementations, the minimum number of users may be a number of users required for approval of the chore modification request. By way of non-limiting example, the minimum number of users may be the number of users of the contribution management environment or another number of users. In some implementations, the minimum number of users may be less than the number of users of the contribution management environment.

Contribution environment update component 158 may be configured to update the contribution management environment. In some implementations, the contribution management environment may be updated such that a change indicated by a chore modification request is reflected. By way of non-limiting example, the contribution management environment may be updated responsive to sufficient approval of the chore modification request being received. By way of non-limiting example, the contribution management environment may be updated responsive to receipt of sufficient approval of a chore addition request. For example, the contribution management environment may be updated such that a chore identified by the chore addition request is managed by the contribution management environment. In some implementations, the contribution management environment may be updated such that requests indicated by the chore modification requests are reflected. By way of non-limiting example, the chore may be a pre-defined chore by virtue of sufficient approval of the chore addition request having been received.

Referring back to FIG. 8, user interface 800 includes a chore modification request indication 852. By way of non-limiting example, chore modification request indication 852 may be an indication of a chore addition request identifying a new chore. Chore modification request indication 852 may include a user identifier 836, a chore identifier 838 of the new chore, and a chore description 840 of the new chore. User identifier 836 may identify a user associated with a client computing platform from which the chore addition request was received. Chore modification request indication 852 may include a minimum number of users 854 required for approval of the chore addition request, a deadline 842 for approval of the chore addition request, a current number of approvals 844, and a remaining number of approvals 846. Chore modification request indication 852 may include an accept button 848 configured to receive user approval of the chore modification request. Completion modification request indication 852 may include a deny button 850 configured to receive user denial of the chore modification request.

Referring back to FIG. 1, In some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 148, 150, 152, 154, 156, 158, 160, 162, 164, 166, 168, 170, 172, 174, and/or other components. Processor(s) 130 may be configured to execute components 148, 150, 152, 154, 156, 158, 160, 162, 164, 166, 168, 170, 172, 174, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 148, 150, 152, 154, 156, 158, 160, 162, 164, 166, 168, 170, 172, and/or 174 are illustrated in FIG. 1 as being implemented within a single processing unit, in implementations in which processor(s) 130 includes multiple processing units, one or more of components 148, 150, 152, 154, 156, 158, 160, 162, 164, 166, 168, 170, 172, and/or 174 may be implemented remotely from the other components. The description of the functionality provided by the different components 148, 150, 152, 154, 156, 158, 160, 162, 164, 166, 168, 170, 172, and/or 174 described below is for illustrative purposes, and is not intended to be limiting, as any of components 148, 150, 152, 154, 156, 158, 160, 162, 164, 166, 168, 170, 172, and/or 174 may provide more or less functionality than is described. For example, one or more of components 148, 150, 152, 154, 156, 158, 160, 162, 164, 166, 168, 170, 172, and/or 174 may be eliminated, and some or all of its functionality may be provided by other ones of components 148, 150, 152, 154, 156, 158, 160, 162, 164, 166, 168, 170, 172, and/or 174. As another example, processor(s) 130 may be configured to execute one or more additional components that may perform some or all of the functionality attributed below to one of components 148, 150, 152, 154, 156, 158, 160, 162, 164, 166, 168, 170, 172, and/or 174.

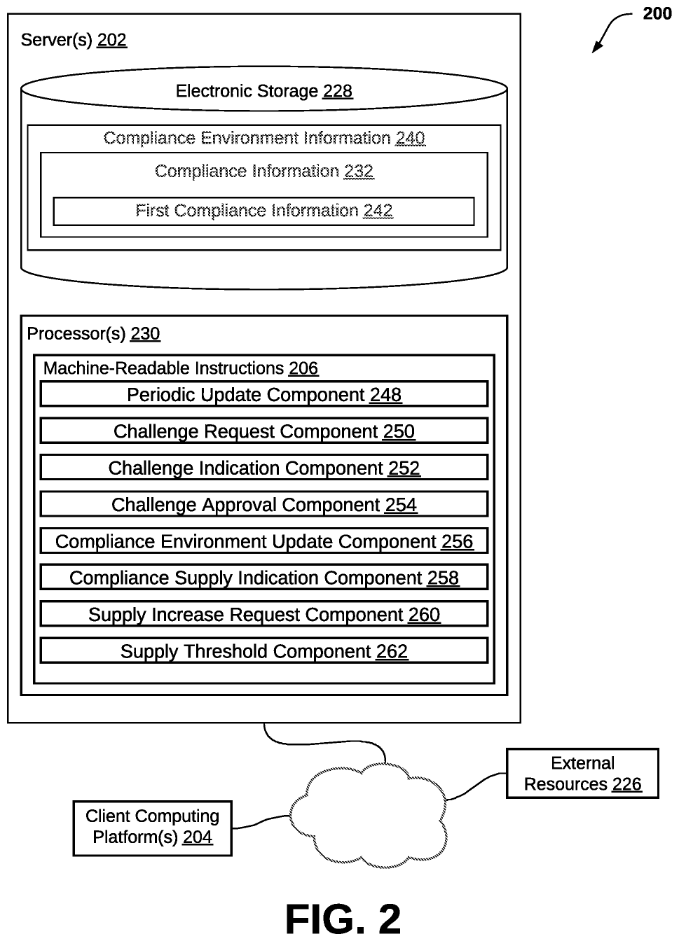

FIG. 2 illustrates a system 200 configured to automatically manage values associated with user activity within a compliance environment, in accordance with one or more implementations. In some implementations, the compliance environment may automatically manage compliance supplies of users of the compliance environment. In some implementations, system 200 may include one or more servers 202, one or more client computing platforms 204, external resources 226, electronic storage 228, and/or other components. Server(s) 202 may be configured to communicate with one or more client computing platforms 204 according to a client/server architecture and/or other architectures. Client computing platform(s) 204 may be configured to communicate with other client computing platforms via server(s) 202 and/or according to a peer-to-peer architecture and/or other architectures. Users may access system 200 via client computing platform(s) 204. In some implementations, individual users may be associated with individual ones of client computing platform(s) 204.

Electronic storage 228 may include non-transitory electronic storage media. Electronic storage 228 may be configured to store compliance environment information 240. Compliance environment information 240 may include compliance information 232 associated with individual ones of the users, an amount of time, a last periodic update timing, a periodic update amount, a challenge request expiration time, and/or other information. In some implementations, compliance information 232 for individual ones of the users may include a user identifier associated with an individual user and a current compliance supply associated with the individual user. In some implementations, current compliance supplies may characterize levels of compliance of individual users at a particular point in time. By way of non-limiting example, an individual compliance supply may be an integer, a fraction, a rational number, an irrational number, and/or another value. By way of non-limiting example, compliance information 232 may include first compliance information 242 for a first user. By way of non-limiting example, first compliance information 242 may include a first user identifier and a first current compliance supply.

In some implementations, the amount of time may denote an amount of time between periodic updates to current compliance supplies of the users. By way of non-limiting example, the current compliance supplies may be periodically increased. For example, periodically increasing the current compliance supplies may indicate satisfactory behavior during the period. In some implementations, the last periodic update timing may indicate a point in time of the last periodic update to the compliance environment. In some implementations, compliance supplies may be bounded by a minimum value, a maximum value, and/or other bounds. In some implementations, the challenge request expiration time may indicate a maximum amount of time between receipt of the challenge request and determination of sufficient approval of the challenge request. Sufficient approval of the challenge request may include receipt of approval of the challenge request from a number of users greater than or equal to a minimum number of users.

Periodic update component 248 may be configured to determine passage of the amount of time since the last compliance supply update timing. In some implementations, the compliance supplies of one or more of the users may be updated periodically. Such periodic updates may occur upon passage of the amount of time. In some implementations, periodic update component 248 may be configured to identify a set of current compliance supplies equal to the maximum value. Periodic update component 248 may be configured to maintain the values of individual ones of the set of current compliance supplies equal to the maximum value. Periodic update component 248 may be configured to identify a set of current compliance supplies near the maximum value. By way of non-limiting example, a current compliance supply may be near the maximum value by virtue of the current compliance supply being greater than or equal to the difference between the maximum value and the periodic update amount. Periodic update component 248 may be configured to update the compliance environment such that the values of individual ones of the set of current compliance values near the maximum value are set to the maximum value.

Periodic update component 248 may be configured to update the current compliance supplies such that individual ones of the current compliance supplies reflect an increase of the periodic update amount. In some implementations, only current compliance supplies less than or equal to the difference between the maximum value and the periodic update amount. In some implementations, the current compliance supplies may be updated responsive to the determination of passage of the amount of time.

Compliance supply indication component 258 may be configured to effectuate presentation of information included in compliance information 232. Compliance supply indication component 258 may be configured to effectuate presentation of the information via one or more client computing platforms 204. By way of non-limiting example, compliance supply indication component 258 may be configured to effectuate presentation of information included in first compliance information 242. For example, compliance supply indication component 258 may be configured to effectuate presentation of user identifiers of the users and current compliance supplies of the users. For example, such a presentation may enable the users to view one or more current compliance supplies of some or all of the users.

Challenge request component 250 may be configured to receive challenge requests from one or more client computing platforms 204. In some implementations, the challenge requests may be entered and/or selected by individual challenging users via one or more client computing platforms 204. In some implementations, an individual challenge may be associated with an individual challenging user by virtue of being received from an individual client computing platform associated with the individual challenging user. In some implementations, a challenging user may enter and/or select a challenge request targeted at a challenged user. In some implementations, an individual challenge request may be targeted at one or more users. By way of non-limiting example, the individual challenging user may select a user of the compliance environment to be the challenged user. In some implementations, the challenge request may indicate a request to update the compliance environment such that a current compliance supply associated with the challenged user is lowered. The current compliance supply associated with the challenged user may be lowered by a particular amount. In some implementations, the particular amount may be automatically determined, determined by the challenging user, determined by another user, and/or determined in some other way. In some implementations, individual particular amounts may be associated with individual challenge requests.

By way of non-limiting example, challenge request component 250 may be configured to receive a first challenge request from a first client computing platform associated with the first user. The first user may have entered and/or selected the first challenge request via the first client computing platform. The first user may have entered and/or selected the first challenge request to be targeted against the second user. By way of non-limiting example, the first challenge request may indicate a request to update the compliance environment such that a second current compliance supply associated with a second user is lowered by a first amount. In some implementations, the first challenge request may include information identifying the second user and information identifying the first amount.

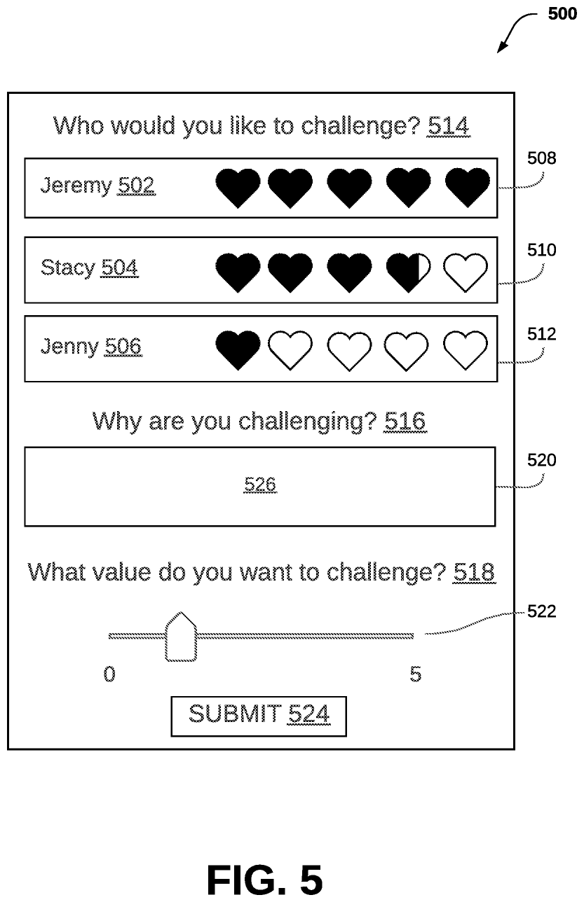

By way of non-limiting example, FIG. 5 depicts an exemplary user interface 500 for transmitting a challenge request from a client computing platform. User interface 500 may include a challenged user query 514, a reasoning query 516, and a challenge amount query 518. Challenged user query 514 may include a user 502, a user 504, and a user 506. User 502 may include a name of user 502 and a current compliance supply 508 associated with user 502. By way of non-limiting example, current compliance supply 508 may have a maximum value for a compliance supply. User 504 may include a name of user 504 and a current compliance supply 510 associated with user 504. User 506 may include a name of user 506 and a current compliance supply 512 associated with user 506. As such, user interface 500 may depict current compliance supplies of users of a compliance environment. In some implementations, user interface 500 may be configured to receive user entry and/or selection of identification of one or more of user 502, user 504, and/or user 506.

In some implementations, user interface 500 may be configured to receive user entry of a reason for challenging one or more of user 502, user 504, and/or user 506 via a text box 526. In some implementations, user interface 500 may be configured to receive user entry and/or selection of an amount to be challenged via a slider 518. In some implementations, user interface 500 may be configured to receive user selection of submission of a challenge request via a button 524.

In some implementations, user interface 500 may be presented to the user via a client computing platform. By way of non-limiting example, a user may select to challenge user 502 via user interface 500. The user may enter an amount to be challenged of “1” using slider 522 included in user interface 500. Upon selection of button 524, a challenge request identifying user 502, the value of slider 522, and/or other information may be transmitted from the client computing platform. By way of non-limiting example, a component that is the same as or similar to challenge request component 250 depicted in FIG. 2 may receive the challenge request.

Returning to FIG. 2, challenge request component 250 may be configured to determine approval minimums indicating minimum numbers of users required to approve individual challenge requests. In some implementations, an individual approval minimum may be determined based on a current compliance supply of a challenged user and/or other information. In some implementations, a low approval minimum may be determined for a challenge request targeted at a challenged user associated with a high current compliance supply. In some implementations, a high approval minimum may be determined for a challenge request targeted at a challenged user associated with a low current compliance supply. By way of non-limiting example, a first approval minimum indicating a minimum number of users required to approve the first challenge request may be determined. The first approval minimum may be determined based on the second current compliance supply.

Challenge indication component 252 may be configured to transmit an indication of individual received challenge requests to one or more client computing platforms 204. In some implementations, the indication may be presented to the users via one or more client computing platforms 204. An individual indication of a challenge request may identify one or more of the challenging user, the challenged user, an amount, a deadline for approval, an approval minimum, and/or other information. In some implementations, the amount may denote an amount by which a current compliance supply associated with the challenged user would be lowered upon approval of the challenge request. By way of non-limiting example, an indication of the first challenge request may identify one or more of the first user, the second user, the first amount, the first approval minimum, and/or other information.

In some implementations, an indication of an individual challenge request may include one or more fields configured to receive user input. In some implementations, the user input may include entry and/or selection of indication of approval and/or disapproval of the challenge request. Users may input such entries and/or selections indicating approval and/or disapproval of the challenge request via one or more client computing platforms 204. In some implementations, the indication may be different for different ones of the users. For example, a different indication may be presented via one or more client computing platforms 204 associated with the challenging user and/or the challenged user than the other users. For example, an indication presented via one or more client computing platforms 204 associated with the challenging user and/or the challenged user may not include fields configured to receive entry and/or selection of indication of approval and/or disapproval of the challenge request. For example, the challenging user and/or the challenged user may or may not be enabled to indicate approval and/or disapproval of the challenge request

Challenge approval component 254 may be configured to receive approval and/or disapproval of challenge requests from one or more client computing platforms 204 associated with one or more users. In some implementations, receiving approval may include receiving user input from one or more client computing platforms 204. By way of non-limiting example, challenge approval component 254 may be configured to receive approval and/or disapproval of the first challenge request from one or more users. Receiving approval and/or disapproval from an individual user may include receiving user input from a client computing platform associated with the individual user.

Challenge approval component 254 may be configured to determine whether sufficient approval of individual challenge requests has been received. In some implementations, determining whether sufficient approval of an individual challenge request has been received may include determining a number of users from which approval of the individual challenge request has been received. In some implementations, determining the number of users may include identifying a number of client computing platforms associated with unique users from which approval of the individual challenge request has been received. In some implementations, approval of a challenge request from a user may not be included in the number of users by virtue of the user being a challenging user and/or a challenged user. In some implementations, the challenging user of an individual challenge request may be considered to have approved the challenge request by virtue of selecting and/or entering the challenge request. In some implementations, determining whether sufficient approval of an individual challenge request has been received may include determining the number of users is greater than or equal to the approval minimum. In some implementations, receiving sufficient approval of a challenge request may indicate the challenge request has been approved. By way of non-limiting example, challenge approval component 254 may be configured to determine sufficient approval of the first challenge request has been received.

Compliance environment update component 256 may be configured to update the compliance environment. In some implementations, the compliance environment may be updated responsive to determination that a challenge request has been approved. In some implementations, the compliance environment may be updated such that a current compliance supply associated with a challenged user is lowered by a particular amount associated with the challenge request. By way of non-limiting example, the compliance environment may be updated such that the second current compliance supply is lowered by the first amount. For example, such an update may be responsive to determining that sufficient approval of the first challenge request has been received.

Challenge approval component 254 may be configured to determine expiration of individual challenge requests. In some implementations, determining an individual challenge request has expired may include determining sufficient approval of the individual challenge request has not been received. In some implementations, determining the individual challenge request has expired may include determining an amount of time that has passed since receipt of the individual challenge request. In some implementations, determining the individual challenge request has expired may include determining the amount of time is greater than and/or equal to the challenge request expiration time.

Compliance environment update component 256 may be configured to update the compliance environment responsive to determination of expiration of individual challenge requests. In some implementations, the compliance environment may be updated such that a current compliance supply associated with a challenging user of the individual challenge request is decreased. By way of non-limiting example, the decrease may be reflective of a particular amount associated with the individual challenge request, an expired request value, and/or another amount. By way of non-limiting example, the expired request value may be included in compliance environment information 240. By way of non-limiting example, the expired request value may indicate a magnitude of a penalty for an expired challenge request.

By way of non-limiting example, the first challenge request may be determined to have expired. The first challenge request may be determined to have expired upon passage of the challenge request expiration time since receipt of the first challenge request. The first challenge request may be determined to have expired by virtue of sufficient approval of the first challenge request not being received. In some implementations, the first current compliance supply may be decreased by an amount reflective of the first amount, the expired request value, and/or another amount.

Compliance supply indication component 258 may be configured to transmit indications of updates to the compliance environment. In some implementations, the indications may be transmitted to one or more client computing platforms 204. In some implementations, the compliance supply indication component 258 may be configured to transmit indications of updates to one or more current compliance supplies associated with users. For example, compliance supply indication component 258 may be configured to transmit an update indicating an individual current compliance supply has been increased and/or decreased. By way of non-limiting example, compliance supply indication component 258 may be configured to transmit an indication of the second current compliance supply being lowered responsive to receipt of sufficient approval of the first challenge request. By way of non-limiting example, compliance supply indication component 258 may be configured to transmit an indication of the first current compliance supply being lowered responsive to determination of expiration of the first challenge request.

Supply increase request component 260 may be configured to receive compliance supply increase requests from one or more client computing platforms 204. In some implementations, a compliance supply increase request may indicate a request to update the compliance environment. In some implementations, a sending user may provide user input indicating a compliance supply increase request via one or more client computing platforms 204. In some implementations, the compliance supply increase request may be received from one or more client computing platforms 204 associated with the sending user responsive to the user input. In some implementations, the user input may include entry and/or selection of an identifier of a receiving user.

In some implementations, a supply increase request may indicate a request to increase a current compliance supply associated with a receiving user by a particular amount. An individual supply increase request may include one or more of a user identifier associated with a sending user, a user identifier associated with a receiving user, information identifying a particular amount, and/or other information. The particular amount may be a preset amount, an amount entered and/or selected by the sending user, an amount automatically determined based on a current compliance supply of a user, and/or determined in another way. In some implementations, the particular amount may be determined automatically and/or manually for individual compliance supply increase requests. In some implementations, the particular amount may be the same for some or all receiving users.

By way of non-limiting example, a first compliance supply increase request may indicate a request to update the compliance environment. The first compliance supply increase request may have been received from a third client computing platform associated with a third user. By way of non-limiting example, the first compliance supply increase request may indicate a request to increase a fourth current compliance supply associated with a fourth user by a second amount. For example, the first compliance supply increase request may include one or more of a user identifier associated with the fourth user, information identifying the second amount, and/or other information.

Compliance environment update component 256 may be configured to update the compliance environment responsive to receipt of individual compliance supply increase requests. In some implementations, updating the compliance environment may include determining whether a receiving user is eligible to receive an increase in a current compliance supply associated with the receiving user. By way of non-limiting example, a user may be ineligible to receive the increase by virtue of having received an increase from a compliance supply increase request within a particular period of time. For example, an individual user may be eligible to receive an increase in current compliance supply from a compliance supply increase request once per week, biweekly, once per month, and/or with another frequency. By way of non-limiting example, a user may be ineligible to receive the increase by virtue of having received one or more increases resulting in an increase of current compliance supply greater than or equal to a particular threshold. In some implementations, the particular threshold may be applicable during a particular period of time.

In some implementations, updating the compliance environment may include increasing a compliance supply associated with a receiving user by a particular amount. The particular amount may be identified by an individual compliance supply increase request. In some implementations, the current compliance supply associated with the receiving user may be increased responsive to determining the receiving user is eligible for such an increase. By way of non-limiting example, the fourth current compliance supply may be increased by the second amount responsive to receipt of the first compliance supply increase request.

Compliance supply indication component 258 may be configured to transmit indications of individual increases to individual compliance supplies of individual users. In some implementations, the indications may be transmitted responsive to the compliance environment being updated. In some implementations, the indications may be transmitted to one or more client computing platforms 204. In some implementations, the indication may depict information regarding a compliance supply increase request. For example, the indication may depict one or more of information identifying a sending user, information identifying a receiving user, a magnitude of increase to an individual current compliance supply, and/or other information. By way of non-limiting example, an indication of the increase of the fourth current compliance supply may be transmitted to one or more client computing platforms 204. By way of non-limiting example, the indication of the increase of the fourth current compliance supply may depict one or more of information identifying the third user, information identifying the fourth user, the second amount, and/or other information.

Supply threshold component 262 may be configured to determine an individual current compliance supply associated with an individual user is below a certain threshold. In some implementations, a current compliance supply associated with a user being below a certain threshold may indicate the user is not compliant within the compliance environment. By way of non-limiting example, the certain threshold may be preset, an amount entered and/or selected by a user, an amount collectively selected by the users, an amount automatically determined, and/or determined in another way. In some implementations, the certain threshold may be the same for some or all users. In some implementations, the certain threshold may be determined automatically and/or manually for individual users. For example, the certain threshold may be determined for individual users periodically.

Compliance supply indication component 258 may be configured to transmit an indication of individual current compliance supplies being below the certain threshold. In some implementations, the indication may be transmitted to one or more client computing platforms 204. In some implementations, the indication may be transmitted to individual users associated with current compliance supplies below the certain threshold. In some implementations, the indication may be transmitted to individual users associated with current compliance supplies above and/or equal to the certain threshold.

In some implementations, the users of the compliance environment may also be users of a contribution management environment. The contribution management environment may be defined by environment information that is the same as or similar to contribution environment information 140 depicted in FIG. 1. Compliance environment update component 256 may be configured to update the compliance environment responsive to determination of one or more users not being compliant within the contribution management environment during a particular window. By way of non-limiting example, such a determination may be the same as or similar to determinations made by balance determination component 166 depicted in FIG. 1. In some implementations, the compliance environment may be updated such that one or more current compliance supplies associated with the one or more users are decreased. By way of non-limiting example, the one or more current compliance supplies may be decreased by a preset amount, an amount entered and/or selected by a user, an amount automatically determined based on a contribution balance of individual ones of the one or more users, and/or determined in another way.

In some implementations, server(s) 202, client computing platform(s) 204, and/or external resources 232 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 202, client computing platform(s) 204, and/or external resources 232 may be operatively linked via some other communication media.

A given client computing platform 204 may include one or more processors configured to execute computer program components. The computer program components may be configured to enable an expert or user associated with the given client computing platform 204 to interface with system 200 and/or external resources 226, and/or provide other functionality attributed herein to client computing platform(s) 204. By way of non-limiting example, the given client computing platform 204 may include one or more of a desktop computer, a laptop computer, a handheld computer, a tablet computing platform, a NetBook, a Smartphone, a gaming console, and/or other computing platforms.

External resources 226 may include sources of information outside of system 200, external entities participating with system 200, and/or other resources. In some implementations, some or all of the functionality attributed herein to external resources 226 may be provided by resources included in system 200.

Server(s) 202 may include electronic storage 228, one or more processors 230, and/or other components. Server(s) 202 may include communication lines, or ports to enable the exchange of information with a network and/or other computing platforms. Illustration of server(s) 202 in FIG. 2 is not intended to be limiting. Server(s) 202 may include a plurality of hardware, software, and/or firmware components operating together to provide the functionality attributed herein to server(s) 202. For example, server(s) 202 may be implemented by a cloud of computing platforms operating together as server(s) 202.

Electronic storage 228 may comprise non-transitory storage media that electronically stores information. The electronic storage media of electronic storage 228 may include one or both of system storage that is provided integrally (i.e., substantially non-removable) with server(s) 202 and/or removable storage that is removably connectable to server(s) 202 via, for example, a port (e.g., a USB port, a firewire port, etc.) or a drive (e.g., a disk drive, etc.). Electronic storage 228 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 228 may include one or more virtual storage resources (e.g., cloud storage, a virtual private network, and/or other virtual storage resources). Electronic storage 228 may store software algorithms, information determined by processor(s) 230, information received from server(s) 202, information received from client computing platform(s) 204, and/or other information that enables server(s) 202 to function as described herein.

Processor(s) 230 may be configured to provide information processing capabilities in server(s) 202. As such, processor(s) 230 may include one or more of a digital processor, an analog processor, a digital circuit designed to process information, an analog circuit designed to process information, a state machine, and/or other mechanisms for electronically processing information. Although processor(s) 230 is shown in FIG. 2 as a single entity, this is for illustrative purposes only. In some implementations, processor(s) 230 may include a plurality of processing units. These processing units may be physically located within the same device, or processor(s) 230 may represent processing functionality of a plurality of devices operating in coordination. Processor(s) 230 may be configured to execute components 248, 250, 252, 254, 256, 258, 260, 262, and/or other components. Processor(s) 230 may be configured to execute components 248, 250, 252, 254, 256, 258, 260, 262, and/or other components by software; hardware; firmware; some combination of software, hardware, and/or firmware; and/or other mechanisms for configuring processing capabilities on processor(s) 230. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 248, 250, 252, 254, 256, 258, 260, 262, and/or other components are illustrated in FIG. 2 as being implemented within a single processing unit, in implementations in which processor(s) 230 includes multiple processing units, one or more of components 248, 250, 252, 254, 256, 258, 260, 262, and/or other components may be implemented remotely from the other components. The description of the functionality provided by the different components 248, 250, 252, 254, 256, 258, 260, 262, and/or other components described below is for illustrative purposes, and is not intended to be limiting, as any of components 248, 250, 252, 254, 256, 258, 260, 262, and/or other components may provide more or less functionality than is described. For example, one or more of components 248, 250, 252, 254, 256, 258, 260, 262, and/or other components may be eliminated, and some or all of its functionality may be provided by other ones of components 248, 250, 252, 254, 256, 258, 260, 262, and/or other components. As another example, processor(s) 230 may be configured to execute one or more additional components that may perform some or all of the functionality attributed below to one of components 248, 250, 252, 254, 256, 258, 260, 262, and/or other components.

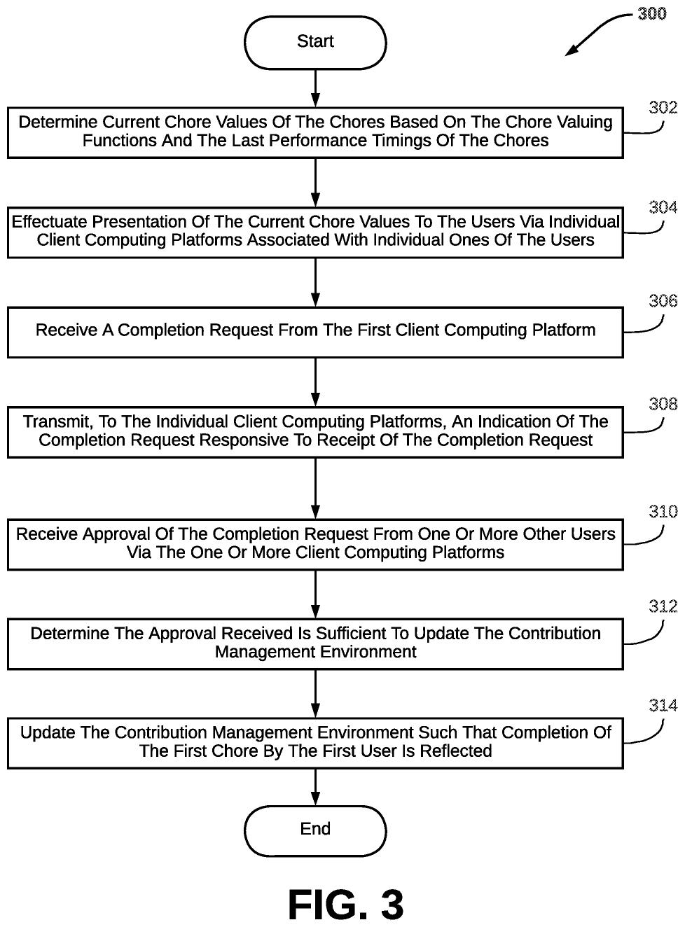

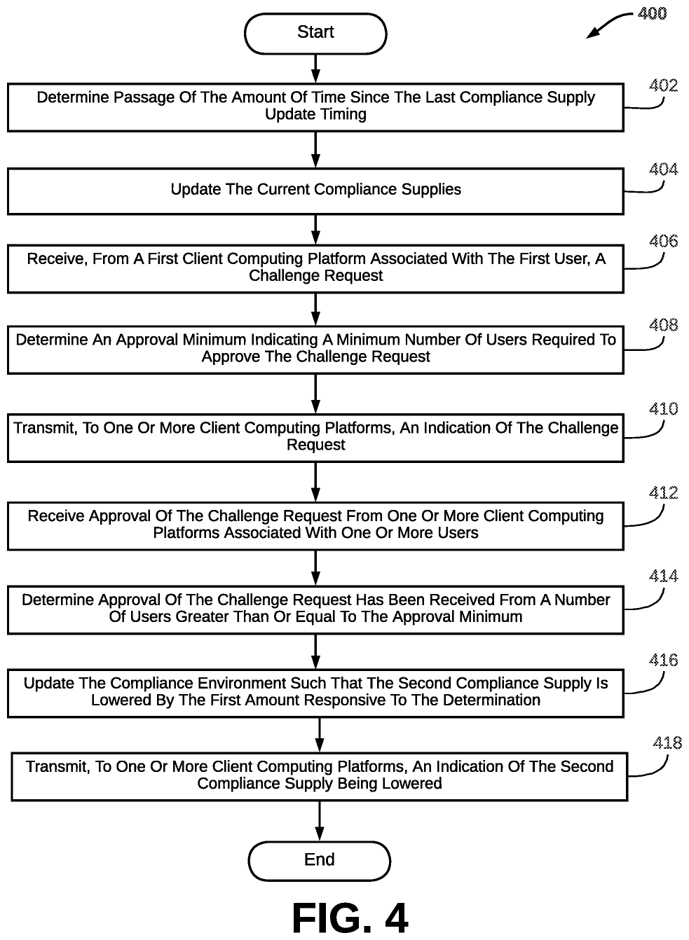

FIG. 3 illustrates a method 300 for automatically managing prioritization and completion of chores within a contribution management environment, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 4 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include determining current chore values of chores managed by a contribution management environment. The current chore values may be determined based on the chore valuing functions, the last performance timings of the chores, and/or other information. By way of non-limiting example, a first current chore value for the first chore may be determined based on the first chore valuing function, the last performance timing of the first chore, and/or other information. Operation 402 may be performed by one or more hardware processors configured by machine-readable instructions including a component that is the same as or similar to current chore value component 148 depicted in FIG. 1, in accordance with one or more implementations.

An operation 304 may include effectuating presentation of the current chore values to the users via individual client computing platforms associated with individual ones of the users. In some implementations, presentation of the current chore values may include presentation of the first current chore value. In some implementations, the presentation may be effectuated to the first user via a first client computing platform. The first client computing platform may be associated with the first user. Operation 304 may be performed by one or more hardware processors configured by machine-readable instructions including a component that is the same as or similar to chore value presentation component 150 depicted in FIG. 1, in accordance with one or more implementations.

An operation 306 may include receiving a completion request from the first client computing platform. In some implementations, the completion request may indicate a request to update the contribution management environment such that completion of the first chore by the first user is reflected. The completion request may include information identifying the first user, information identifying the first chore, and/or other information. Operation 306 may be performed by one or more hardware processors configured by machine-readable instructions including a component that is the same as or similar to completion request component 152 depicted in FIG. 1, in accordance with one or more implementations.

An operation 308 may include transmitting, to the individual client computing platforms, an indication of the completion request. In some implementations, the indication may be transmitted responsive to receipt of the completion request. The indication may identify the first user, the first chore, the first current chore value, and/or other information. The indication may enable one or more other users to approve the completion request via one or more client computing platforms associated with the one or more other users. Operation 308 may be performed by one or more hardware processors configured by machine-readable instructions including a component that is the same as or similar to completion request indication component 154 depicted in FIG. 1, in accordance with one or more implementations.

An operation 310 may include receiving approval of the completion request from one or more other users via the one or more client computing platforms. Operation 310 may be performed by one or more hardware processors configured by machine-readable instructions including a component that is the same as or similar to completion approval component 156 depicted in FIG. 1, in accordance with one or more implementations.

An operation 312 may include determining the approval received is sufficient to update the contribution management environment. Operation 312 may be performed by one or more hardware processors configured by machine-readable instructions including a component that is the same as or similar to completion approval component 156 depicted in FIG. 1, in accordance with one or more implementations.

An operation 314 may include updating the contribution management environment such that completion of the first chore by the first user is reflected. The contribution management environment may be updated responsive to receiving sufficient approval of the completion request. Updating the contribution management environment may include updating the first contribution balance associated with the first user such that the first contribution balance reflects the first current chore value responsive to being updated. Updating the contribution management environment may include updating the first current chore value of the first chore such that the first current chore value reflects a low value responsive to being updated. Operation 314 may be performed by one or more hardware processors configured by machine-readable instructions including a component that is the same as or similar to contribution environment update component 158 depicted in FIG. 1, in accordance with one or more implementations.

FIG. 4 illustrates a method 400 for automatically managing values associated with user activity within a compliance environment, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include determining passage of the amount of time since the last compliance supply update timing. Operation 402 may be performed by one or more hardware processors configured by machine-readable instructions including a component that is the same as or similar to periodic update component 248 depicted in FIG. 2, in accordance with one or more implementations.

An operation 404 may include updating the current compliance supplies such that individual ones of the current compliance supplies reflect an increase of the periodic update amount. In some implementations, the update may be responsive to the determination of passage of the amount of time. Operation 404 may be performed by one or more hardware processors configured by machine-readable instructions including a component that is the same as or similar to periodic update component 248 depicted in FIG. 2, in accordance with one or more implementations.

An operation 406 may include receiving a challenge request from a first client computing platform associated with the first user. The challenge request may indicate a request to update the compliance environment such that a second current compliance supply associated with a second user is lowered by a first amount. The challenge request may include information identifying the second user, information identifying the first amount, and/or other information. Operation 406 may be performed by one or more hardware processors configured by machine-readable instructions including a component that is the same as or similar to challenge request component 250 depicted in FIG. 2, in accordance with one or more implementations.

An operation 408 may include determining an approval minimum indicating a minimum number of users required to approve the challenge request. The approval minimum may be determined based on the second current compliance supply. Operation 408 may be performed by one or more hardware processors configured by machine-readable instructions including a component that is the same as or similar to challenge request component 250 depicted in FIG. 2, in accordance with one or more implementations.

An operation 410 may include transmitting an indication of the challenge request. The indication may be transmitted to one or more client computing platforms. The indication may identify one or more of the first user, the second user, the first amount, the approval minimum, and/or other information. The indication of the challenge request may enable one or more users to approve the challenge request via the one or more client computing platforms. Operation 410 may be performed by one or more hardware processors configured by machine-readable instructions including a component that is the same as or similar to challenge indication component 252 depicted in FIG. 2, in accordance with one or more implementations.

An operation 412 may include receiving approval of the challenge request from one or more client computing platforms associated with one or more users. Operation 412 may be performed by one or more hardware processors configured by machine-readable instructions including a component that is the same as or similar to challenge approval component 254 depicted in FIG. 2, in accordance with one or more implementations.

An operation 414 may include determining approval of the challenge request has been received from a number of users greater than or equal to the approval minimum. Operation 414 may be performed by one or more hardware processors configured by machine-readable instructions including a component that is the same as or similar to challenge approval component 254 depicted in FIG. 2, in accordance with one or more implementations.

An operation 416 may include updating the compliance environment such that the second current compliance supply is lowered by the first amount responsive to the determination. Operation 416 may be performed by one or more hardware processors configured by machine-readable instructions including a component that is the same as or similar to compliance environment update component 256 depicted in FIG. 2, in accordance with one or more implementations.

An operation 418 may include transmitting an indication of the second current compliance supply being lowered. In some implementations, the indication may be transmitted to one or more client computing platforms. Operation 418 may be performed by one or more hardware processors configured by machine-readable instructions including a component that is the same as or similar to compliance supply indication component 258 depicted in FIG. 2, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to automatically manage prioritization and completion of chores within a contribution management environment, the system comprising:
non-transitory electronic storage configured to store environment information defining a contribution management environment, wherein the contribution management environment manages chores to be completed by users of the contribution management environment, wherein the environment information includes chore information for the chores managed by the contribution management environment and user information for the users of the contribution management environment,
wherein the chore information for individual ones of the chores includes a chore identifier, a baseline chore value, a last performance timing, and a chore valuing function, wherein the baseline chore value characterizes an initial chore value of an individual chore within the contribution management environment wherein the chores include a first chore, wherein the environment information includes first chore information for a first chore, wherein the first chore information includes a first chore identifier of the first chore, a first baseline chore value of the first chore, a last performance timing of the first chore, and a first chore valuing function of the first chore,
wherein the user information for individual ones of the users includes a user identifier and a contribution balance, wherein the individual contribution balances associated with the individual ones of the users characterize a current chore value of chores completed by the individual ones of the users, wherein the users include a first user, and wherein the user information includes first user information for the first user, wherein the first user information includes a first user identifier of the first user and a first contribution balance associated with the first user; and
one or more hardware processors configured by machine-readable instructions to:
determine current chore values of the chores based on the chore valuing functions and the last performance timings of the chores, wherein a first current chore value for the first chore is determined based on the first chore valuing function and the last performance timing of the first chore;
effectuate presentation of the current chore values to the users via individual client computing platforms associated with individual ones of the users, wherein presentation of the current chore values including the first current chore value to the first user via a first client computing platform associated with the first user is effectuated;
receive a completion request from the first client computing platform, wherein the completion request indicates a request to update the contribution management environment such that completion of the first chore by the first user is reflected, wherein the completion request includes information identifying the first user and information identifying the first chore;
transmit, to the individual client computing platforms, an indication of the completion request responsive to receipt of the completion request, wherein the indication identifies the first user, the first chore, and the first current chore value, wherein the indication enables one or more other users to approve the completion request via one or more client computing platforms associated with the one or more other users;
receive approval of the completion request from one or more other users via the one or more client computing platforms;
determine the approval received is sufficient to update the contribution management environment; and
update the contribution management environment such that completion of the first chore by the first user is reflected, wherein the contribution management environment is updated responsive to receiving sufficient approval of the completion request, wherein updating the contribution management environment includes
(i) updating the first contribution balance associated with the first user such that the first contribution balance reflects the first current chore value responsive to being updated, and
(ii) updating the first current chore value of the first chore such that the first current chore value is lowered responsive to being updated.

2. The system of claim 1, wherein a second chore is managed by the contribution management environment, wherein the environment information includes second chore information for the second chore, wherein the second chore information includes a second chore identifier of the second chore, a baseline second chore value of the second chore, last performance timing of the second chore, and a second chore valuing function wherein the one or more hardware processors are further configured to:
receive a priority increase request indicating a request to prioritize the first chore from one or more client computing platforms responsive to receipt of the priority increase request, wherein the priority increase request includes the first chore identifier and one or more chore identifiers of one or more other chores, wherein the one or more chore identifiers includes the second chore identifier;
update a subset of chore information for the one or more other chores, wherein updating the subset of the chore information for the one or more other chores includes lowering one or more baseline chore values of the one or more other chores and/or the growth over time of the chore values of the one or more other chores, wherein the baseline second chore value and/or the second chore valuing function is lowered; and
update a subset of the first chore information, wherein updating the subset of the first chore information includes increasing the first baseline chore value and/or the first chore valuing function, wherein such increase is reflective of the lowering of the baseline chore values and/or the lowering of the growth over time of the chore values of the one or more other chores.

3. The system of claim 1, wherein a second chore is managed by the contribution management environment, wherein the environment information includes second chore information for the second chore, wherein the second chore information includes a second chore identifier of the second chore, a current second chore value of the second chore, last performance timing of the second chore, and a second chore valuing function wherein the one or more hardware processors are further configured to:
receive a priority decrease request indicating a request to decrease priority of the first chore from one or more client computing platforms, wherein the priority decrease request includes the first chore identifier and one or more chore identifiers of one or more other chores, wherein the one or more chore identifiers includes the second chore identifier;
update a subset of chore information for the one or more other chores, wherein updating the subset of the chore information for the one or more other chores includes increasing one or more baseline chore values of the one or more other chores and/or the growth over time of the chore values of the one or more other chores, wherein the baseline second chore value and/or the second chore valuing function is increased; and
update a subset of the first chore information, wherein updating the subset of the first chore information includes decreasing the first baseline chore value and/or the first chore valuing function, wherein such decrease is reflective of the increase of the baseline chore values and/or the increase of the growth over time of the chore values of the one or more other chores.

4. The system of claim 1, wherein the one or more hardware processors are further configured to effectuate presentation of the current chore values of the chores via one or more client computing platforms responsive to the contribution management environment being updated.

5. The system of claim 1, wherein an individual contribution balance reflects current chore value of chores completed by the individual ones of the users during a sliding window of time or during a current window of time, wherein the one or more hardware processors are further configured to effectuate presentation of the contribution balances via one or more client computing platforms.

6. The system of claim 1, wherein an individual contribution balance reflects current chore value of chores completed by an individual user during a sliding window of time or during a current window of time, wherein the environment information includes an indication of a window duration, wherein the window duration denotes a length of time of windows for tracking contribution balances of the users, wherein the user information includes individual contribution balance requirements, wherein the individual contribution balance requirements denote minimum contribution balances to be associated with individual ones of the users during individual windows of time, wherein the first user information includes a first contribution balance requirement denoting a minimum contribution balance to be associated with the first user at the conclusion of a particular window of time.

7. The system of claim 6, wherein the one or more hardware processors are further configured to:
determine a first window has concluded, wherein determining the first window has concluded includes identifying an amount of time since the individual contribution balances associated with individual ones of the users have been reset and determining the amount of time is greater than or equal to the window duration;
determine the first contribution balance is less than the first contribution balance requirement responsive to determining the first window has concluded;
transmit an indication that the first contribution balance is less than the first contribution balance requirement to one or more client computing platforms; and
reset the contribution balances of the users of the contribution management environment such that the contribution balances reflect the users have not completed any chores during a second window.

8. The system of claim 6, wherein the one or more hardware processors are further configured to:
receive a break request from a client computing platform associated with the first user, wherein the break request indicates a duration of absence of the first user from the contribution management environment during an individual window;
determine the break request is a valid break request, wherein determining validity of the break request includes determining whether the duration of absence is greater than or equal to a minimum break duration and/or less than or equal to a maximum break duration;
update the first chore valuing function such that growth over time of a first chore value of the first chore is decreased during the individual window; and
update the first contribution balance requirement such that the first contribution balance requirement is lowered to reflect the duration of absence of the first user.

9. The system of claim 1, wherein the chore information for the individual ones of the chores includes a priority value such that the first chore information includes a first priority value, wherein a priority value characterizes priority of an individual chore within the contribution management environment, wherein priority values of the chores managed by the contribution management environment sum to a constant value at a given time.

10. The system of claim 1, wherein determining the approval received is sufficient to update the contribution management environment includes determining approval has been received from a number of users greater than or equal to a minimum number of users required for approval of the completion request.

11. The system of claim 1, wherein the one or more hardware processors are further configured to:
receive a chore modification request from one or more client computing platforms associated with a user, wherein the chore modification request indicates a request to update the contribution management environment such that one or more of addition, removal, and/or change of one or more chores is reflected, wherein the chore modification request includes a subset of chore information for the one or more chores;
receive approval of the chore modification request from one or more via the one or more client computing platforms;
determine the approval received is sufficient to update the contribution management environment; and
update the contribution management environment such that the one or more of addition, removal, and/or change of the one or more chores is reflected, wherein updating the contribution management environment such that
(i) addition of the one or more chores is reflected includes updating the contribution management environment such that the one or more chores are managed by the contribution management environment,
(ii) removal of the one or more chores is reflected includes updating the contribution management environment such that the one or more chores are no longer managed by the contribution management environment, and/or
(iii) change of the one or more chores is reflected includes updating the contribution management environment such that chore information for the one or more chores is changed.

12. A system configured to automatically manage values associated with user activity within a compliance environment, the system comprising:
non-transitory electronic storage configured to store compliance environment information defining a compliance environment, wherein the compliance environment information includes compliance information associated with individual ones of the users, an amount of time, a last periodic update timing, and a periodic update amount, wherein the compliance information for individual ones of the users includes a user identifier associated with an individual user and a current compliance supply associated with the individual user, wherein first compliance information for a first user includes a first user identifier and a first current compliance supply, wherein current compliance supplies characterizes levels of compliance of individual users at a particular point in time, wherein the amount of time denotes an amount of time between periodic increases in current compliance supplies of the users, wherein the compliance environment automatically manages compliance supplies of users of the compliance environment;
one or more hardware processors configured by machine-readable instructions to:
determine passage of the amount of time since the last compliance supply update timing;
update the current compliance supplies such that individual ones of the current compliance supplies reflect an increase of the periodic update amount responsive to the determination of passage of the amount of time;
receive, from a first client computing platform associated with the first user, a challenge request, wherein the challenge request indicates a request to update the compliance environment such that a second current compliance supply associated with a second user is lowered by a first amount, wherein the challenge request includes information identifying the second user and information identifying the first amount;
determine an approval minimum indicating a minimum number of users required to approve the challenge request, wherein the approval minimum is determined based on the second current compliance supply;
transmit, to one or more client computing platforms, an indication of the challenge request, wherein the indication identifies one or more of the first user, the second user, the first amount, and the approval minimum, wherein the indication of the challenge request enables one or more users to approve the challenge request via the one or more client computing platforms;
receive approval of the challenge request from one or more client computing platforms associated with one or more users;
determine approval of the challenge request has been received from a number of users greater than or equal to the approval minimum;
update the compliance environment such that the second current compliance supply is lowered by the first amount responsive to the determination; and
transmit, to one or more client computing platforms, an indication of the second current compliance supply being lowered.

13. The system of claim 12, wherein compliance supplies are bounded by a minimum value and a maximum value.

14. The system of claim 13, wherein updating the current compliance supplies includes:
maintaining the value of individual current compliance supplies equal to the maximum value;
updating the value of individual current compliance supplies near the maximum value to be equivalent to the maximum value; and
updating the value of other individual current compliance supplies such that the current compliance supplies are increased by the periodic update amount.

15. The system of claim 12, wherein the one or more hardware processors are further configured to:
effectuate presentation of user identifiers of the users and current compliance supplies of the users.

16. The system of claim 12, wherein the non-transitory electronic storage is further configured to store a challenge request expiration time, wherein the challenge request expiration time indicates a maximum amount of time between receipt of the challenge request and receipt of approval of the challenge request from a number of users greater than or equal to the approval minimum, wherein, upon passage of the challenge request expiration time without receipt of sufficient approval of the challenge request, the first current compliance supply is decreased.

17. The system of claim 16, wherein the first current compliance supply is decreased by an amount reflective of the first amount.

18. The system of claim 12, wherein the one or more hardware processors are further configured to:
receive, from a third client computing platform associated with a third user, a compliance supply increase request, wherein the compliance supply increase request indicates a request to update the compliance environment such that a fourth current compliance supply associated with a fourth user is increased by a second amount, wherein the compliance supply increase request includes a user identifier associated with the fourth user and information identifying the second amount;
update the compliance environment such that the fourth current compliance supply is increased by the second amount responsive to receipt of the compliance supply increase request; and
transmit, to one or more client computing platforms, an indication of the increase of the fourth current compliance supply.

19. The system of claim 12, wherein the one or more hardware processors are further configured to:
determine an individual current compliance supply associated with an individual user is below a certain threshold; and
transmit, to one or more client computing platforms associated with the individual user, an indication of the individual current compliance supply being below the certain threshold.
